(19) United States
(12) Patent Application Publication
(10) Pub. No.: US 2025/0176739 A1
(43) Pub. Date: Jun. 5, 2025

(54) CHILD SAFETY GATE WITH BARRIER TENSIONING MEANS

(71) Applicant: Joran Lundh, Hong Kong (CN)

(72) Inventor: Joran Lundh, Hong Kong (CN)

(21) Appl. No.: 18/840,436

(22) PCT Filed: Mar. 10, 2023
(86) PCT No.: PCT/EP2023/056153

§ 371 Date: Aug. 21, 2024

(30) Foreign Application Priority Data
Mar. 11, 2022 (SE) 2250317-1

(51) Int. Cl. A47G 5/02

(52) U.S. Cl. CPC A47G 5/02

(57) ABSTRACT

A child safety gate with a flexible retractable barrier part (3) wound on a rotatable roller (R) includes a locking device (10) connected to the rotatable roller (R). In an unlocked position, the locking device (10) allows extraction of the barrier part (3) in an unwinding direction of the roller (R). In a locked position, the locking device (10) prevents further extraction of the barrier part (3) in the unwinding direction. The locking device (10) includes an actuator (11) movable between a first position corresponding to the unlocked position, and a second position corresponding to the locked position. Upon actuating the actuator (11) in the closed gate position, the barrier part (3) is reversed in a direction opposite the pull-out direction to provide extra tensioning of the barrier part (3).

### TECHNICAL FIELD

The present invention relates in general to a child safety gate for a passageway, such as a door opening, as well as a locking device to be included in such a child safety gate.

### BACKGROUND

Child safety gates, also referred to as child safety barriers, have been used for decades. By the end of 1990, Lascal AB (Sweden) developed a new version of a child safety gate with the gate part made of mesh fabric wound onto and retractable from a vertical axle fastened to one side of a door opening. This retractable child safety gate was first introduced to the world market by Lascal AB, and later by Lascal Ltd (Hong Kong) under the tradename “KiddyGuard®”.

Further examples of child safety gate structures are disclosed for instance in WO94/00664A1 and U.S. Pat. No. 5,690,317A. These kinds of child safety gates have a barrier part made of a flexible material which is wound onto a vertical roller accommodated in a roller unit mounted at one side of the passageway. The barrier part is unwound and rolled out from the roller unit when the gate is closed. In the closed position, the free end of the barrier part is attached to the opposite side of the passageway. In the closed position, the barrier part is typically slightly tensioned by a return spring pulling the barrier part in a direction opposite the unwinding direction. Further background art is reflected for instance in U.S. Pat. Nos. 7,219,709B1, 6,375,165B1, US20080121354A1 and US20150376942A1.

A problem with most current gate structures of this kind is that, when the gate is closed and the barrier is pressed down or lifted upwards for instance by a child, it is the spring force alone that determines the degree of vertical movement of the barrier in its closed position. Thus, if the spring force is too large, the gate would require too much closing force, which is inconvenient for the user. Contrarily, if the spring force is too small, a child could easily step over the barrier or crawl under it, which is dangerous and could cause serious injuries. From the above, it is understood that there is room for improvements.

### SUMMARY

An object of the present invention is to solve or at least mitigate the problems related to prior art. This object is achieved by means of a child safety gate of the invention having the features set forth in appended claim 1; preferred embodiments being defined in the related dependent claims. Subject to the invention is also a locking device having the features set forth in appended claim 13.

In a first aspect, there is provided a child safety gate with a flexible retractable barrier part wound on a rotatable roller. A locking device is connected to the rotatable roller and it has at least an unlocked position and a locked position. The locking device is configured to in its unlocked position allow at least extraction of the barrier part in an unwinding direction of the roller, and in its locked position prevent further extraction of the barrier part in the unwinding direction. Furthermore, the locking device includes an actuating assembly movable between a first position corresponding to the unlocked position of the locking device, and a second position corresponding to the locked position of the locking device. Upon actuating the actuating assembly, the barrier part is reversed in a direction opposite the unwinding direction. By this improved child safety gate, an efficient and secure tensioning of the flexible barrier part is achieved in the locked position.

In an embodiment, the actuating assembly is actuated by a translational movement of the actuating assembly from its first position to its second position.

In a further embodiment, the child safety gate includes a locking mechanism movably connected to the actuating assembly and configured to reverse the barrier part in the direction opposite the unwinding direction.

Actuation of the actuating assembly may induce a rotational movement engaging a first member and a second member of the locking mechanism, thereby reversing the roller and tensioning the flexible retractable barrier part. Preferably, the first member and the second member of the locking mechanism are configured to be rotatably coupled to each other.

The first member and the second member may have corresponding gears which are configured to mesh with each other upon actuation of the actuating assembly.

Preferably, the second member of the locking mechanism is fixedly connected to the roller.

In an embodiment, the first member has a cap with a cam protruding radially outwards from the cap. There may also be more than one cam protrusion.

Moreover, the locking device may further have a casing with a cam groove in which the protruding cam is configured to slide from a first end to a second end when the first member and the second member are engaged.

In an embodiment, the first member of the locking mechanism is connected to the actuating assembly via a connector. The actuating assembly is preferably actuated manually by a user.

In a second aspect, there is provided a locking device for a child safety gate having a flexible retractable barrier part wound on a rotatable roller. The locking device is connectable to the rotatable roller and it has at least an unlocked position and a locked position. In its unlocked position, the locking device is configured to allow at least extraction of the barrier part in an unwinding direction of the roller, and in its locked position to prevent further extraction of the barrier part in the unwinding direction. The locking device includes an actuating assembly movable between a first position corresponding to the unlocked position of the locking device, and a second position corresponding to the locked position. Upon actuating the actuating assembly, the barrier part is reversed in a direction opposite the unwinding direction by means of the locking mechanism.

In general, the inventive locking device is configured to make child gates safer through an additional locking step which, in the closed gate position, further tensions the retractable barrier part as compared to conventional safety gates comprised in the art. The additional locking and barrier tensioning effect is achieved by ingenious locking means co-operating with the actuating assembly. The locking means may include the previously described members of the locking mechanism which in a preferred embodiment involves sliding locking engagement of a cam protrusion in a cam groove between a first and a second distinct position. In other words, upon locking the locking device, the roller is reversed by the distinct movement of the cam in the cam groove, thereby tensioning the flexible retractable barrier part which is already stretched between opposing sides of a passageway. Effectively, the barrier part is reversed in a direction opposite the pull-out direction to provide extra tensioning of the barrier part.

An advantage of the tensioning is that a wide range of openings may be secured, and thus there is an adaptability to different homes. Furthermore, the tensioning results in a relatively more tensioned barrier, with a tensioning effect both on the upper part of the barrier facing away from the floor, as well as at the bottom part of the barrier, near the floor. This way, thanks to the tensioning effect of the locking device, a child, or pet, is even further prevented from climbing over or crawling under the safety gate as before.

### BRIEF DESCRIPTION OF THE DRAWINGS

By way of example, embodiments of the present invention will now be described with reference to the accompanying drawings, in which:

FIG. 1 shows a child safety gate in an open state arranged at a passageway,

FIG. 2 shows the child safety gate of FIG. 1 in a closed state,

FIG. 3 shows a locking device of the child safety gate in an unlocked state,

FIG. 4 is a detailed view of the unlocked locking device of FIG. 3,

FIG. 5 is a detailed view of the locking device of FIG. 3 in a locked state,

FIG. 6 shows a section of the locking device of FIG. 4 in an unlocked state,

FIG. 7 shows a section of the locking device of FIG. 5 in a locked state, and

FIG. 8 shows an alternative way of mounting the child safety gate of FIGS. 1-2.

### DETAILED DESCRIPTION OF EMBODIMENTS

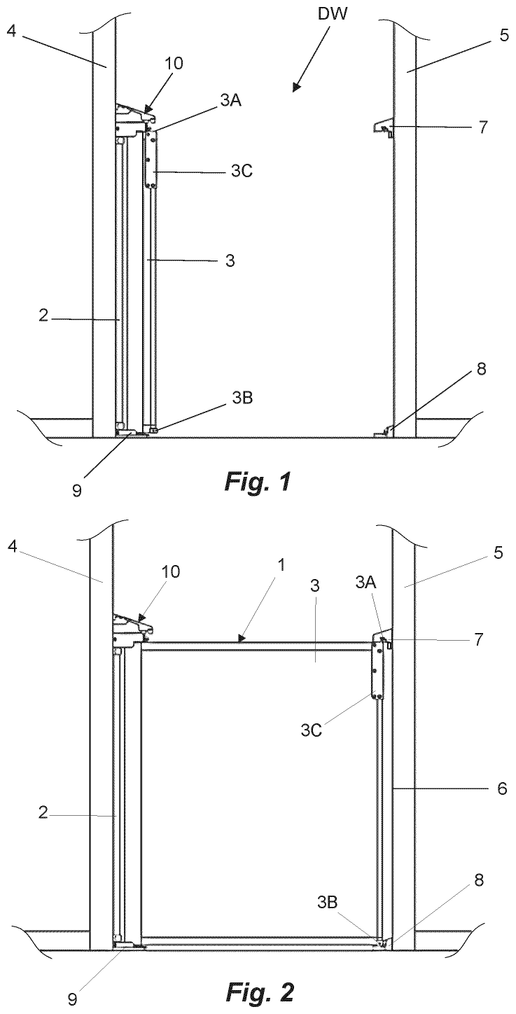

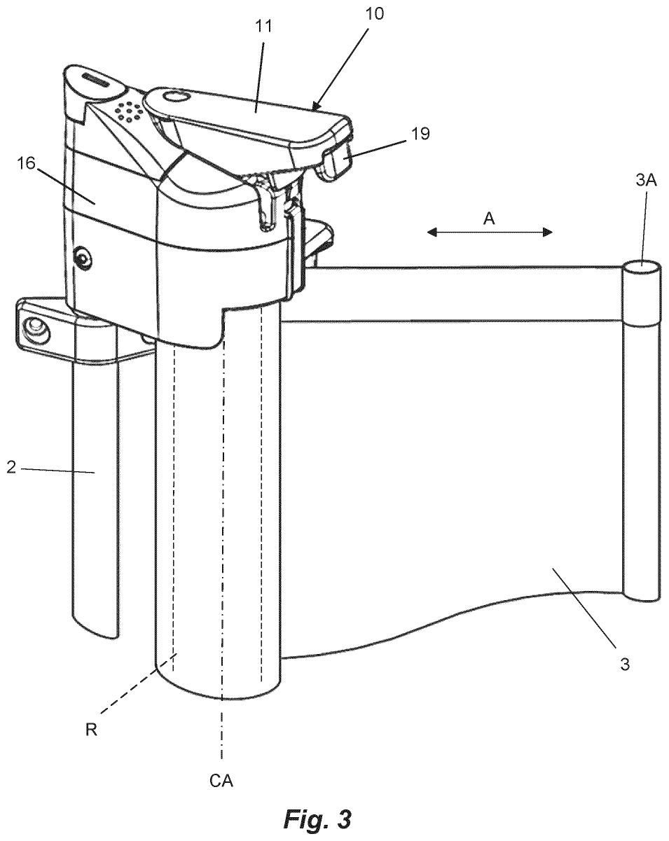

With reference to FIGS. 1-2, a child safety gate 1, also referred to as a retractable safety barrier is shown. The child safety gate 1 is installed at a passageway, such as a door opening, and includes a flexible barrier part 3 wound onto a rotatable roller R (see FIG. 3). Alternatively, the barrier part 3 may also be referred to as a flexible barrier sheet or screen. For instance, the barrier part 3 may be made of a natural or synthetic material, such as cloth or woven fabric, or any flexible material that may be attached to and wound onto a roller R. Optionally, the roller with the barrier part is accommodated in a roller housing having an elongate slot out of which the barrier part can be retracted (not shown).

As shown in FIGS. 1 and 2, the gate 1 also has a support structure 2 which is mounted to a vertical wall portion 4 of a passageway, such as a doorway DW defined by the wall portion 4 and an opposite wall portion 5, to which a fastening device 6 of the child safety gate 1 is mounted. For instance, the wall portion 4, 5 may be parts of a door frame. The fastening device 6 includes upper holding means 7 and lower holding means 8 adapted to receive and hold the barrier part 3 when the child safety gate 1 is in its closed position. Optionally, the upper holding means are interconnected by a rail to form a single unit (not shown). The support structure 2 of the gate 1 and the fastening device 6 are preferably mounted to the wall portions 4, 5 by means of screws, although other special fittings, nails, adhesive or strong magnets may be used as well. Preferably, the support structure 2 and the fastening device 6 are mounted substantially parallel to each other, as defined by their longitudinal extensions.

To close the doorway DW, the barrier part 3 is pulled out manually and a securing means 3A at an upper free end portion thereof is attached to the fastening device 6 at the upper holding means 7 mounted to the opposite wall portion 5. The fastening device 6 is adapted to hold the barrier part 3 in its extracted position. A corresponding securing means 3B at a lower free end portion of the barrier 3 part is attached to the fastening device 6 at the lower holding means 8. Preferably, the barrier part 3 is provided with a barrier handle 3C for convenience of the user.

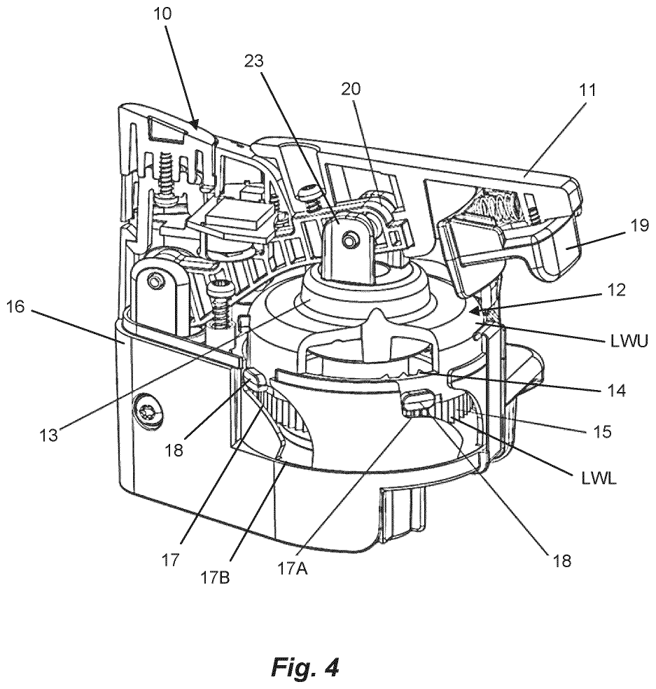

Moreover, the child safety gate 1 includes a locking device 10 on the top of the support structure 2, i.e. the upper end portion of the support structure 2, which will be further described in relation to FIGS. 4-7 below. The child safety gate 1 has an open position and a closed position which correspond to an unlocked position and a locked position of the locking device 10, respectively.

The roller R is connected to the locking device 10 at its upper end, see FIG. 3. At its lower end, the roller R is connected to a rollback device 9 which is configured to provide a torque for rotating the roller R, to roll back the barrier part 3 onto the roller R after the barrier part 3 has been pulled out. Put differently, the barrier part 3 is biased such that it is automatically reversed or rolled back to a wound state from an unwound state.

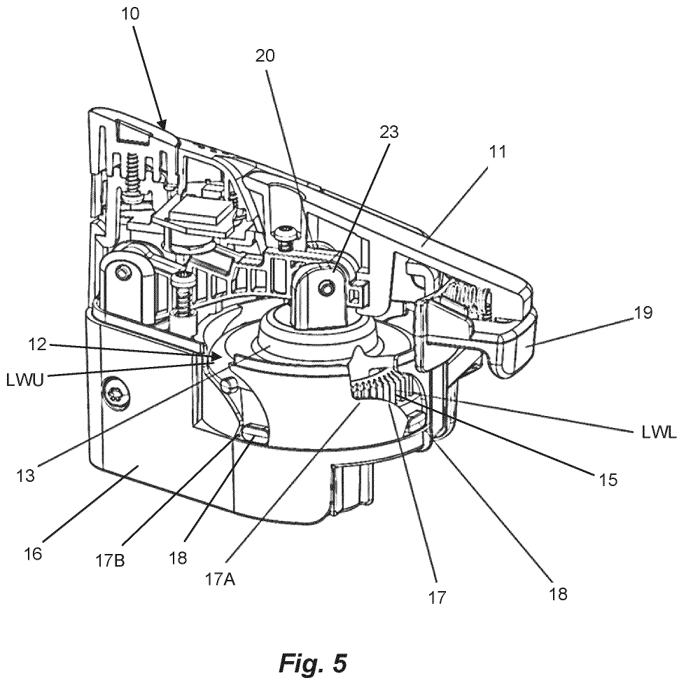

As briefly mentioned, the locking device 10 has at least a locked state, or position, and an unlocked state. In its unlocked state, the locking device 10 is configured to allow at least extraction of the barrier part 3. In other words, in the unlocked state of the locking device 10, the barrier part 3 is extractable in an unwinding direction of the roller R, and retractable in a winding direction of the roller R once extracted. In its locked state, the locking device 10 is configured to indirectly rotate the barrier part 3 in a winding direction of the roller R such that the barrier part 3 is tensioned. The tensioning is a result of an internal locking mechanism 12 (see FIGS. 4 and 5) which will be further described below. Hence, in the locked state, or position, of the locking device 10, further extraction of the barrier part 3 is prevented and the barrier part 3 is tensioned in a way such that a child, or pet, is further prevented from crawling under or climbing over the safety gate, as compared to most child safety gates which simply lock the gate, without further tensioning.

FIG. 3 shows the locking device 10 in an unlocked state, in which the barrier part 3 is movable back and forth in a direction illustrated by the double arrow A. Here, the barrier part 3 is partly extended and is wound on/off the roller R. The dashed lines mark the circumference of the roller R. A rotation axis of the roller R coincides with a center axis CA of the locking device 10.

Now turning to FIGS. 4-7, an overview of the locking device 10 and its components will be presented.

As mentioned, the locking device 10 is movable between an unlocked position and a locked position. The unlocked position is illustrated in FIGS. 1, 3, 4 and 6, and the locked position is illustrated in FIGS. 2, 5, 7 and 8. The transition of the locking device 10 between these two positions is actuated or carried out by an actuating assembly, or actuator having a locking handle 11. As shown, the locking handle 11 is movable between a first position corresponding to the unlocked position of the locking device 10 and a second position corresponding to the locked position of the locking device 10. For instance, the locking handle 11 may be lifted and lowered, corresponding to an open position and a closed position of the child safety gate 1, respectively. When lifted, the locking handle 11 disengages, or disconnects, the internal locking mechanism 12 mentioned previously, which unlocks the locking device 10, and thereby also the safety gate 1, and enables the barrier part 3 to be at least extracted. Optionally, the gate 1 is unlocked by rotating or pulling the locking handle 11. In other words, the locking handle 11 should not be interpreted as being restricted to be shaped as a handle per se. For instance, in FIG. 3, the locking handle 11 is lifted upwards and the barrier part 3 is free to be rolled on/off the roller R.

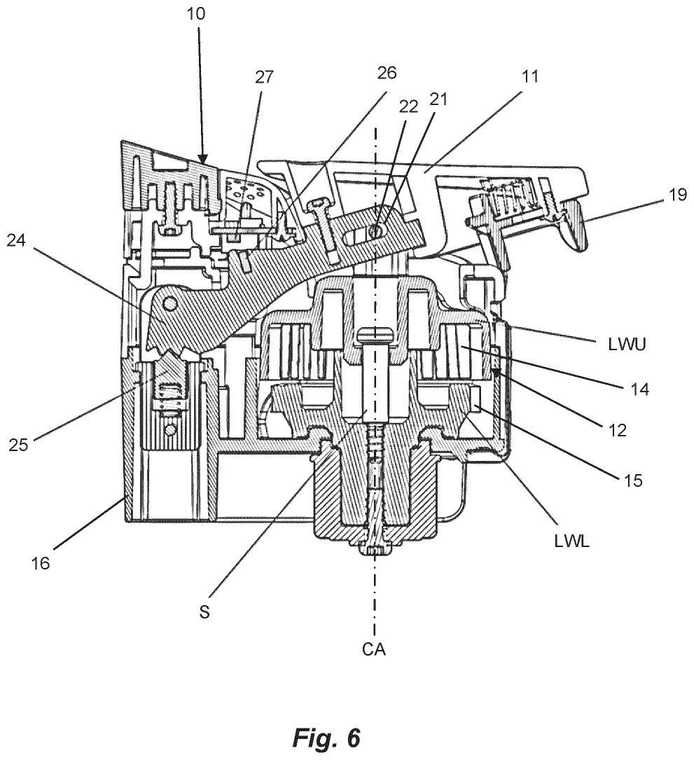

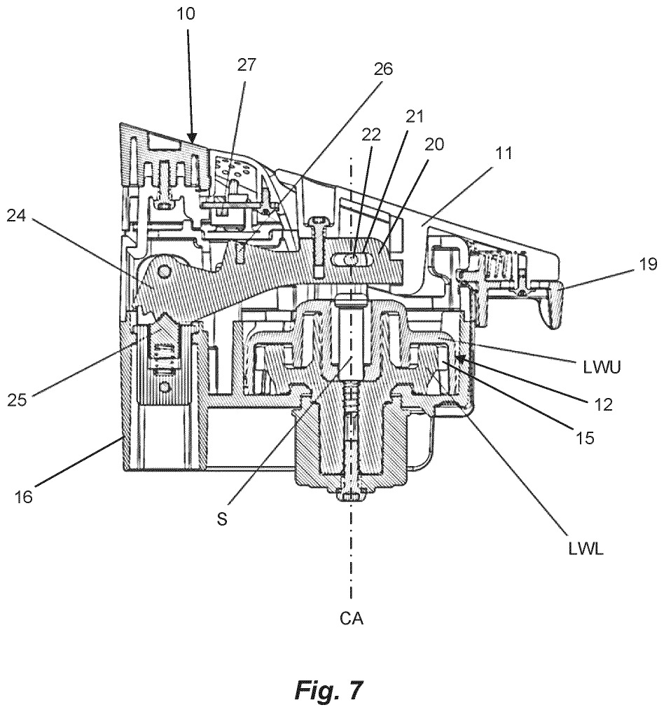

The locking mechanism 12 has a first member in the shape of an upper locking wheel LWU, and a second member in the shape of a lower locking wheel LWL. Together, the upper and lower locking wheels LWU, LWL are configured to be rotatably coupled to each other. Moreover, the upper and lower locking wheels LWU, LWL are rotatable with respect to each other when the locking device 10 is unlocked. In the embodiment shown in FIGS. 6 and 7, the wheels LWU, LWL are connected via a screw S.

The upper locking wheel LWU has an outer cap 13 and an inner gear 14 along an inner circumference of the cap 13, see FIG. 4. The lower locking wheel LWL is fixedly connected to the roller R and has an outer gear 15 adapted to cooperate with the corresponding inner gear 14 of the upper locking wheel LWU. When the locking handle 11 is lifted in a direction upwards from the floor, the inner and outer gears 14, 15 are disengaged, as seen for instance in FIG. 6. Conversely, when the locking handle 11 is pressed in a direction towards the floor, the inner and outer gears 14, 15 mesh with each other, as seen in FIG. 7. Optionally, there may be additional gears (not shown) collaborating in the engagement between the upper locking wheel LWU and the lower locking wheel LWL.

Put differently, a rotational engagement between the upper locking wheel LWU and the lower locking wheel LWL is induced by pushing the locking handle 11 towards the upper locking wheel LWU in a direction substantially perpendicular to the center axis CA running through the locking device 10. The center axis CA corresponds in this case to a rotational axis of the upper and lower locking wheels LWU, LWL. As illustrated in FIGS. 4-7, and as more clearly in FIGS. 6 and 7, the upper locking wheel LWU is movable axially towards and away from the lower locking wheel LWL along the center axis CA of the locking device 10 as a response to the lifting or lowering of the actuating locking handle 11.

Turning back to FIG. 3, the locking device 10 has a casing 16. In FIGS. 4-7, most of the casing 16 is removed for illustration purposes, in order to show the interior of the locking device 10. From FIGS. 4 and 5, it is clear that the locking device 10 is provided with an inclined cam groove 17 in which a corresponding cam or cam projection 18 is configured to slide. The cam groove 17, which may also be referred to as a rotation groove 17, is semi-circular or arc-shaped. This is schematically illustrated in FIGS. 4 and 5. The cam projection 18, in this example shown as a knob, is arranged on a side of the cap 13 of the upper locking wheel LWU opposite the inner gear 14, and is slidable in the rotation groove 17 between a first, distinct upper end and a second, distinct lower end of the rotation groove 17. As an example, when the locking handle 11 is lifted, the knob 18 slides from the lower end to the upper end, as the locking wheels LWU, LWL are disengaged. In this case, the locking mechanism 12 is being deactivated. Conversely, as the upper locking wheel LWU and the lower locking wheel LWL are engaged, the knob 18 slides from the upper end to the lower end. Preferably, the knob 18 protrudes radially outwards from the cap 13. The cam projection 18 may also be in the shape of a pin, or the like.

In FIGS. 4 and 5, only two knobs 18 and grooves 17 are shown. However, in practice, there may be one, two, or more of each. The knobs 18 are arranged spaced apart along the surface of the cap 13 of the upper locking wheel LWU. Moreover, the rotation grooves 17 and knobs 18 are arranged at corresponding positions along the circumference of the locking mechanism 12. Preferably, the knobs 18 and rotation grooves 17 are spaced substantially equidistantly along the locking mechanism 12. From FIG. 4, where the locking handle 11 is lifted, it is clear that the knob 18 is located at the upper end of the rotation groove 17 and in FIG. 5, where the locking handle 11 is lowered, the knob 18 has slid down to the lower end of the rotation groove 17 in a winding direction of the roller R.

When the inner gear 14 of the upper locking wheel LWU and the outer gear 15 of the lower locking wheel LWL are in contact, a further movement of the upper locking wheel LWU towards the lower locking wheel LWL, such as when a user pushes down the actuating locking handle 11, urges the knob 18 to slide from the upper end of the rotation groove 17 to the lower end of the rotation groove 17 such that the gears 14, 15 of the upper locking wheel LWU and the lower locking wheel LWL mesh. This way, the locked flexible retractable barrier part 3 is not only locked, but also tensioned. Hence, the actuation of the locking handle 11 induces a rotational movement engaging the upper locking wheel LWU and the lower locking wheel LWL of the locking mechanism 12, thereby reversing the roller R and tensioning the flexible retractable barrier part 3 in a direction opposite the unwinding direction of the roller R.

For increased safety during operation, the locking handle 11 may be equipped with a lock release element, such as a lock release button 19. A purpose of the lock release button 19 is to keep the locking handle 11 in the locked position when the child safety gate 1 is to be closed. The lock release button 19 is spring biased such that when a user pulls the lock release button 19, the locking handle 11 may be lifted. When the biasing spring is contracted, which occurs when a user pulls the lock release button 19, the locking handle 11 may be moved, such as for instance lifted upwards. This is illustrated in FIGS. 3, 4 and 6. When the locking handle 11 is lifted, the gate, i.e. the flexible barrier part 3, can be pulled out and/or retracted. Contrarily, when the actuating locking handle 11 is pushed down from the lifted position, the child safety gate 1, once secured at the opposite wall portion 5 from the locking device 10 and the roller R, the flexible barrier part 3 is stretched and tensioned by the locking mechanism 12.

Upon actuating the actuator, in this case lifting the locking handle 11, the flexible retractable barrier part 3 is reversed in a direction opposite the unwinding direction of the roller R by means of the locking mechanism 12. It is the action of the locking mechanism 12 which determines whether the barrier part 3 may be stretched/retracted. Put differently, the locking mechanism 12 ensures the tensioning of the barrier part 3 when the gate is closed and the locking device 10 is in its locked state. This occurs when the knob 18 has moved to the lower end of the rotation groove 17, as seen in FIG. 5.

As an example, the actuator 11 can, when actuated, provide for full retraction of the barrier part 3. In other words, the actuator 11 may reverse the barrier part 3 all the way back into the roller R.

To translate a substantially pivotal movement from the locking handle 11 to a vertically displaceable rotational movement of the internal locking mechanism 12 along the center axis CA of the locking device 10, the locking mechanism 12 is movably connected to the locking handle 11 via a series of intermediate elements 20-25 (see description below), which together may be regarded as a translation assembly.

The translational movement of the actuating locking handle 11 may be described as a linear displacement towards the upper locking wheel LWU, which in turn induces a rotational movement of the upper locking wheel LWU towards the lower locking wheel LWL. Optionally, the translational movement of the locking handle 11 is described as a roto-translatory displacement, whereby a linear displacement of the locking handle 11, or actuator, along the center axis CA of the locking device 10 is translated into a rotational movement of the locking mechanism 12. Furthermore, the translational movement of the locking handle 11 may be described as a rotational movement which in turn induces a further rotational movement in the locking mechanism 12 once actuated, for instance, by rotation.

The locking handle 11 is connected to a locking arm 20, which is provided with a slot 21 in an end portion thereof, in which a rivet 22 is configured to run between a first position corresponding to the unlocked position of the locking device 10, and a second position corresponding to the locked position of the locking device 10. The rivet 22 is coupled to a connector 23 (shown in FIGS. 4 and 5) which in turn is connected to the cap 13 of the upper locking wheel LWU of the locking mechanism 12. Hence, when the locking handle 11 is lifted, the locking arm 20 is automatically raised, the connector 23 moves via the movement of the rivet 22 in the slot 21, such that the upper locking wheel LWU follows the movement of the locking handle 11, i.e. upwards and away from the lower locking wheel LWL, and thus, the safety gate 1 is unlocked and the retractable barrier 3 can be pulled out and/or retracted. Correspondingly, when the locking handle 11 is pushed down, the locking arm 20 is moved downwards in a direction towards the upper locking wheel LWU. Thus, the gate 1 is locked and the barrier part 3 is stretched.

Furthermore, the locking arm 20 has a toothed end portion 24 opposite the slotted end portion, configured to engage with a matching tooth on a spring biased element 25. As shown, the spring biased element 25 is located in the locking device casing 16 at a level of the lower locking wheel LWL and gives the locking handle 11 distinctive upper and lower positions when it is in engaged with the toothed end portion 24 of the locking arm 20. This stepwise engagement between the teeth is shown in FIGS. 6 and 7.

Preferably, the locking device 10 is also equipped with a sensor device, for instance consisting of a magnet 26 which may be located on the locking arm 20 and sensed by a magnet sensor 27, such as a PCB magnet sensor, located in the locking device 10. For instance, the sensor device may be provided in the casing 16 of the locking device 10. The magnet 26 and sensor 27 are shown in FIGS. 6 and 7. If the gate 1 stays open for a predetermined amount of time, such as for instance more than about 20 seconds, the sensor device turns on an alarm system of the locking device 10 which alerts the user.

Hence, via the series of intermediate elements 20-25 the locking arm 20 translates the movement of the locking handle 11 to a rotational movement of the upper locking wheel LWU and the lower locking wheel LWL of the locking mechanism 12 such that the inner gear 14 meshes with the outer gear 15 when the locking handle 11 moves from the unlocked position to the locked position of the locking device 10. In this movement, the knob 18 arranged on the cap 13 of the upper locking wheel LWU slides from an upper end of the rotation groove 17 to the lower end, thereby reversing the roller R, and thus also the flexible retractable barrier part 3 wound around it, in a direction opposite the unwinding direction of the roller R. In the embodiment described herein, this occurs when the locking handle 11 is pushed downwards in a direction towards the upper locking wheel LWU. As briefly explained above, conversely, when the locking handle 11 is lifted, as illustrated in FIGS. 4 and 6, it disengages, or disconnects, the upper locking wheel LWU and the lower locking wheel LWL of the internal locking mechanism 12, thereby unlocking the safety gate 1.

The barrier tensioning mechanism can also be described as follows. After having secured the safety gate barrier part 3 at the opposite side of the passageway to be blocked, the rollback device 9 rolls back the barrier part 3 so that it is stretched between the opposing sides of the opening. Next, the actuating locking handle 11 is pushed in a direction towards the upper locking wheel LWU, the inner gear 14 of the upper locking wheel LWU first contacts the lower locking wheel LWL having corresponding outer gears 15 and being fixed to a roller R on which the barrier part 3 is wound. When further pushing down the locking handle 11, the two locking wheels LWU and LWL, now connected, are forced to rotate in the opposite direction of the unwinding direction of the roller R as the rotation knob 18 of the upper locking wheel LWU follows the rotation groove 17. This rotation further stretches the barrier part 3. In particular, it is the movement of the knob 18 in the rotation groove 17 which determines the degree of tensioning of the barrier part 3. As an example, the tensioning is substantially the same for a 80 cm wide passage as for a 60 cm wide passage.

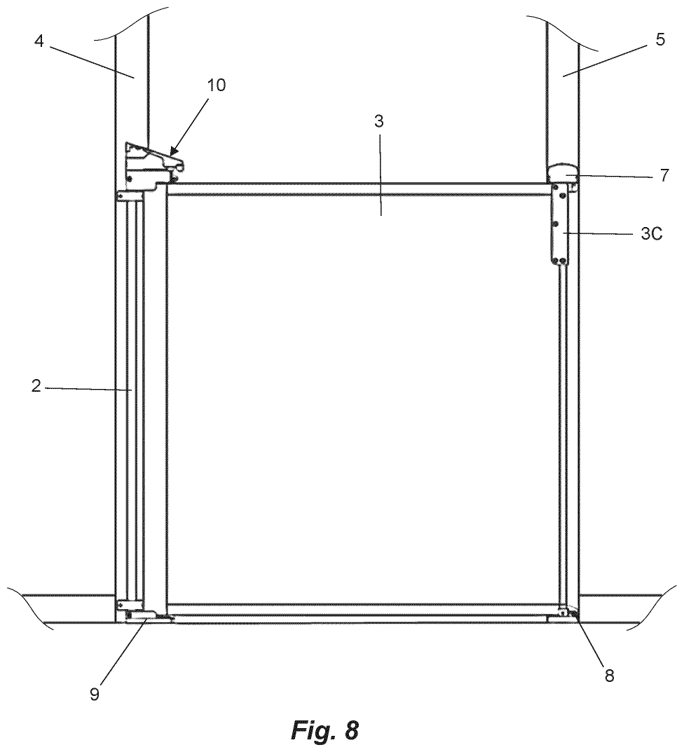

With reference to FIG. 8, an alternative mounting of the child safety gate 1 is shown. The same principles apply for the locking of the gate by the locking device 10 and its related features as described above.

It should be appreciated that even though numerous characteristics and advantages of the present invention have been set forth in the foregoing description, together with details of the structure and function of the invention, the description is illustrative only, and changes may be made in detail, especially in matters of shape, size, and arrangement of parts within the scope of the invention to the full extent indicated by the appended claims. Hence, modifications are feasible without departing from the spirit of the invention defined in the appended claims. For instance, other movements of the actuator and related members of the barrier tensioning and locking means can be used as long as the aimed-at extra tensioning of the barrier part is achieved; in a direction opposite to the pull-out direction.

1. A child safety gate with a flexible retractable barrier part wound on a rotatable roller, and a locking device connected to the rotatable roller; wherein the locking device has at least an unlocked position and a locked position, wherein the locking device is configured to in its unlocked position allow at least extraction of the barrier part in an unwinding direction of the roller, and wherein the locking device is configured to in its locked position prevent further extraction of the barrier part in said unwinding direction; wherein said locking device comprises an actuating assembly movable between a first position corresponding to said unlocked position of the locking device, and a second position corresponding to said locked position of the locking device; and wherein—upon actuating the actuating assembly—the barrier part is reversed in a direction opposite said unwinding direction.

2. The child safety gate according to claim 1, wherein the actuating assembly is actuated by a translational movement of the actuating assembly from its first position to its second position.

3. The child safety gate according to claim 1, further comprising a locking mechanism movably connected to the actuating assembly and configured to reverse the barrier part in said direction opposite the unwinding direction.

4. The child safety gate according to claim 3, wherein actuation of the actuating assembly induces a rotational movement engaging a first member and a second member of the locking mechanism, thereby reversing the roller and tensioning the flexible retractable barrier part.

5. The child safety gate according to claim 4, wherein the first member and the second member of the locking mechanism are configured to be rotatably coupled to each other.

6. The child safety gate according to claim 4, wherein the first member and the second member are rotatable with respect to each other when the locking device is in said unlocked position.

7. The child safety gate according to claim 4, wherein the first member and the second member have corresponding gears which are configured to mesh with each other upon actuation of the actuating assembly.

8. The child safety gate according to claim 4, wherein the second member of the locking mechanism is fixedly connected to the roller.

9. The child safety gate according to claim 4, wherein the first member has a cap with a cam protruding radially outwards from said cap.

10. The child safety gate according to claim 9, wherein the locking device further comprises a casing with a cam groove in which said cam is configured to slide from a first end to a second end when the first member and the second member are engaged.

11. The child safety gate according to claim 4, wherein the first member of the locking mechanism is connected to the actuating assembly via a connector.

12. The child safety gate according to claim 1, wherein the actuating assembly is actuated manually by a user.

13. A locking device for a child safety gate having a flexible retractable barrier part wound on a rotatable roller, wherein the locking device is connectable to the rotatable roller, said locking device having at least an unlocked position and a locked position; wherein the locking device is configured to in its unlocked position allow at least extraction of the barrier part in an unwinding direction of the roller; wherein the locking device is configured to in its locked position prevent further extraction of the barrier part in said unwinding direction; wherein said locking device comprises an actuating assembly movable between a first position corresponding to said unlocked position of the locking device, and a second position corresponding to said locked position of the locking device; and wherein—upon actuating the actuating assembly—the barrier part is reversed in a direction opposite said unwinding direction.
